(19) United States
(12) Patent Application Publication
(10) Pub. No.: US 2023/0151266 A1
(43) Pub. Date: May 18, 2023

(54) DRIED SHALE INHIBITOR ADDITIVES

(71) Applicant: Halliburton Energy Services, Inc., Houston, TX (US)

(72) Inventors: Preston May, Houston, TX (US); Jeffrey J. Miller, Houston, TX (US)

(21) Appl. No.: 17/527,525

(22) Filed: Nov. 16, 2021

(51) Int. Cl. C09K 8/60; C09K 8/86; E21B 21/00

(52) U.S. Cl. CPC C09K 8/607; C09K 8/86; E21B 21/00; C09K 2208/12

(57) ABSTRACT

Methods and compositions for using shale inhibitor additives in subterranean formations, and specifically, to dried shale inhibitor additives and methods for use are provided. In one embodiment, the methods include providing a dried shale inhibitor additive that includes a precipitate of at least one liquid amine shale inhibitor; allowing at least a portion of the dried shale inhibitor additive to dissolve in a treatment fluid including an aqueous base fluid; and introducing the treatment fluid into a wellbore penetrating at least a portion of a subterranean formation.

### BACKGROUND

The present disclosure relates to methods and compositions for using shale inhibitor additives in subterranean formations.

Treatment fluids are used in a variety of operations that may be performed in subterranean formations. As referred to herein, the term “treatment fluid” will be understood to mean any fluid that may be used in a subterranean application in conjunction with a desired function and/or for a desired purpose. The term “treatment fluid” does not imply any particular action by the fluid. Treatment fluids often are used in, e.g., well drilling, completion, and stimulation operations. Examples of such treatment fluids include, among others, drilling fluids, well cleanup fluids, workover fluids, conformance fluids, gravel pack fluids, acidizing fluids, fracturing fluids, spacer fluids, and the like.

During drilling of subterranean wellbores, various strata that include reactive shales may be encountered. The term “shale” may refer to materials that may “swell,” or increase in volume, when exposed to water. Examples of these shales may include certain types of clays (e.g., bentonite). Reactive shales may be problematic during drilling operations because of, among other factors, their tendency to degrade when exposed to aqueous media such as aqueous-based drilling fluids. This degradation, of which swelling is one example, can result in undesirable drilling conditions and/or undesirable interference with the drilling fluid. For instance, the degradation of the shale may interfere with attempts to maintain the integrity of drilled cuttings traveling up the wellbore until such time as the cuttings can be removed by solids control equipment located at the surface.

One technique used to counteract the propensity of aqueous drilling fluids to interact with reactive shales in a formation involves the use of certain additives in aqueous drilling fluids that may inhibit shale, e.g., additives that may demonstrate a propensity for reducing the tendency of shale to absorb water. Liquid shale inhibitor additives have been used to inhibit shale, but, in certain cases, may be difficult to handle.

### BRIEF DESCRIPTION OF THE DRAWINGS

These drawings illustrate certain aspects of some of the embodiments of the present disclosure and should not be used to limit or define the claims.

FIG. 1 is a diagram illustrating an example of a system that may be used in accordance with certain embodiments of the present disclosure.

FIG. 2 is a diagram illustrating an example of a wellbore drilling assembly that may be used in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The present disclosure relates to methods and compositions for using shale inhibitor additives in subterranean formations, and specifically, to dried shale inhibitor additives and methods for use. More specifically, in certain embodiments, the methods of the present disclosure include providing a dried shale inhibitor additive that includes a precipitate of at least one liquid amine shale inhibitor, allowing at least a portion of the dried shale inhibitor additive to dissolve in a treatment fluid including an aqueous base fluid, and introducing the treatment fluid into a wellbore penetrating at least a portion of a subterranean formation. In some embodiments, the methods of the present disclosure include providing at least one liquid amine shale inhibitor, mixing the at least one liquid amine shale inhibitor with a solvent in which the at least one liquid shale inhibitor is substantially or entirely insoluble to produce a precipitate, and drying the precipitate to produce a dried shale inhibitor additive. In some embodiments, the compositions of the present disclosure include a dried shale inhibitor additive including a precipitate of at least one liquid amine shale inhibitor.

Among the many potential advantages to the methods and compositions of the present disclosure, only some of which are alluded to herein, the methods and compositions of the present disclosure may provide a dried shale inhibitor additive that may be easier to handle than certain liquid shale inhibitor additives, which may require additional equipment (e.g., drums). In certain embodiments, the methods and compositions of the present disclosure may provide a dried shale inhibitor additive that has reduced shipping weight and/or cost, reduced volume and/or product footprint at the rig, reduced storage space, reduced packing cost, and reduced potential for liquid leaks as compared to certain liquid shale inhibitor additives. In certain embodiments, the methods and compositions of the present disclosure may provide a dried shale inhibitor additive that has a reduced water weight as compared to certain liquid shale inhibitor additives. In certain embodiments, the methods and compositions of the present disclosure may provide a dried shale inhibitor additive that is more potent weight for weight as compared to certain liquid shale inhibitor additives. In certain embodiments, the methods and compositions of the present disclosure may provide substantially or entirely salt-free dried shale inhibitor additives. In certain embodiments, the methods and compositions of the present disclosure may provide a dried shale inhibitor additive that is manufactured more sustainably than certain shale inhibitor additives, due in part to that the solvent may be reused. In certain embodiments, the methods and compositions of the present disclosure may provide a homogenous liquid composite that may be precipitated to produce a dried shale inhibitor additive that is more homogenous than a dry powder blend (e.g., a dry mix composition produced by mixing at least two dry mix components).

The dried shale inhibitor additive of the present disclosure may include at least one shale inhibitor. The shale inhibitors of the present disclosure may act to inhibit shale by any mechanism, whether known or unknown. In certain embodiments, the shale inhibitor may be an amine shale inhibitor. In some embodiments, the amine shale inhibitor may include at least one amine. The amine may be a primary amine, a secondary amine, a tertiary amine, a quaternary amine, a neutral species of the forgoing, a protonated species of the forgoing along with a counter anion to balance charge, a derivative of the foregoing, and any combination thereof.

The dried shale inhibitor additive of the present disclosure may be prepared by drying a liquid shale inhibitor (e.g., a liquid amine shale inhibitor). The liquid shale inhibitor may be an aqueous liquid shale inhibitor.

The dried shale inhibitor additive of the present disclosure may include a precipitate of a liquid shale inhibitor (e.g., a liquid amine shale inhibitor). In some embodiments, the dried shale inhibitor additive may be produced by a method including precipitating the liquid shale inhibitor (e.g., the liquid amine shale inhibitor). In certain embodiments, the liquid shale inhibitor may be precipitated using a solvent in which the liquid shale inhibitor is substantially or entirely insoluble. In certain embodiments, the liquid shale inhibitor may be precipitated using a solvent that is a poor solvent for the shale inhibitor. A poor solvent may be a solvent in which interactions between shale inhibitor molecules are more energetically favorable than interactions between solvent molecules and shale inhibitor molecules. In some embodiments, the liquid shale inhibitor (e.g., a liquid amine shale inhibitor) may be mixed with the solvent to produce the precipitate of the liquid shale inhibitor. The solvent used to precipitate the shale inhibitor of the present disclosure may be miscible with water. In some embodiments, a miscible mixture of the solvent and water (e.g., water from the liquid amine shale inhibitor) may create a homogenous solvent blend that the shale inhibitor is substantially or entirely insoluble in, thus causing the precipitation to occur.

Examples of solvents that may precipitate the liquid shale inhibitor include, but are not limited to, acetone, isopropyl alcohol, methanol, ethanol, propanol and propanol isomers, butanol and butanol isomers, dichloromethane, tetrahydrofuran, ethyl acetate, acetonitrile, dimethylformamide, dimethyl sulfoxide, hexamethylphosphoramide, propylene carbonate, ethyl lactate, ethylene glycol, diethylene glycol, propylene glycol, and any combination thereof. In certain embodiments, the solvent may be screened to determine if it is a suitable solvent to precipitate a particular liquid shale inhibitor. In certain embodiments, the solvent is added to an aqueous solution including the liquid shale inhibitor in an amount sufficient to cause at least a portion of the liquid shale inhibitor to precipitate. A person skilled in the art, with the benefit of this disclosure, will recognize how to screen for a solvent in which the liquid shale inhibitor is substantially or entirely insoluble that may be included in the methods and compositions of the present disclosure.

In certain embodiments, the solvent may be easily dryable. In some embodiments, the solvent may not react with the shale inhibitor. In some embodiments, at least a portion of the solvent may be separated from the aqueous solution and recovered. In some embodiments, at least a portion of the recovered solvent may be reused to precipitate additional liquid shale inhibitor.

In certain embodiments, the precipitate of the liquid shale inhibitor may be collected (e.g., by filtration) and dried (e.g., using a vacuum pump) to produce the dried shale inhibitor additive. The dried shale inhibitor additive may be sacked and used as a dry, free flowing shale inhibitor product for use in, e.g., a drilling fluid or drill-in fluid.

The dried shale inhibitor additive of the present disclosure may include two or more components. In certain embodiments, the dried shale inhibitor additive may include two or more shale inhibitors (e.g., amine shale inhibitors). In some embodiments, the dried shale inhibitor additive may be produced by precipitating at least two shale inhibitors (e.g., amine shale inhibitors) to produce a precipitate.

In certain embodiments, the dried shale inhibitor additive of the present disclosure may include a precipitate of a homogenous liquid composite. In certain embodiments, the dried shale inhibitor additive may be produced by a method including precipitating the homogenous liquid composite. In certain embodiments, the homogenous liquid composite may include an aqueous liquid mixture. In certain embodiments, the aqueous liquid mixture may include at least two liquid shale inhibitors (e.g., at least two amine shale inhibitors). In some embodiments, the aqueous liquid mixture may include at least one liquid shale inhibitor (e.g., a liquid amine shale inhibitor) and at least one liquid additive. In certain embodiments, the aqueous liquid mixture may include at least one liquid shale inhibitor and at least one solid additive dissolved in the aqueous liquid mixture. In some embodiments, the solid additive may be a solid shale inhibitor. In certain embodiments, the components of the aqueous liquid mixture may be liquid blended. The homogenous liquid composite may be precipitated using a solvent in which the homogenous liquid composite is substantially or entirely insoluble to produce the precipitate. In certain embodiments, the precipitate may be collected (e.g., by filtration) and dried (e.g., using a vacuum pump) to produce the dried shale inhibitor additive. Producing the dried shale inhibitor additive by a method including precipitating the homogenous liquid composite may result in a shale inhibitor additive that is more homogenous than a dry powder blend (e.g., a dry mix composition produced by mixing at least two dry mix components).

In some embodiments, the dried shale inhibitor additive may be a solid. In some embodiments, the dried shale inhibitor additive may be a solid powder. In some embodiments, the dried shale inhibitor additive may be further incorporated into a multi-component dry powder blend (e.g., a dry mix composition) that may include other components such as a lost circulation material and additional solid additives.

In certain embodiments, the dried shale inhibitor additive of the present disclosure may include particles of various sizes. In certain embodiments, the dried shale inhibitor additive may include particles having an average particle diameter ranging from about 0.1 micron to about 500 microns, from about 0.1 micron to about 400 microns, or from about 0.1 microns to about 300 microns. In certain embodiments, the dried shale inhibitor additive may include particles having a diameter of 500 microns or smaller, 400 microns or smaller, or 300 microns or smaller. In some embodiments, the dried shale inhibitor additive may include particles having a diameter of from about 0.1 micron to about 500 microns. In certain embodiments, the dried shale inhibitor additive may include particles that exhibit a particle size distribution between about 0.1 micron and about 2,000 microns. For example, in some embodiments, the dried shale inhibitor additive may include particles that have a median (d50) particle size distribution of from about 2.5 microns to about 1,000 microns. In certain embodiments, the dried shale inhibitor additive may include particles that exhibit a d50 particle size distribution of 1,000 microns or smaller, 750 microns or smaller, 500 microns or smaller, 250 microns or smaller, 100 microns or smaller, or 50 microns or smaller.

In certain embodiments, the dried shale inhibitor additive of the present disclosure may have the same or greater potency as compared to an equivalent amount of a liquid shale inhibitor, as measured by weight. For example, the dried shale inhibitor additive may have at least a 5% increase, at least a 10% increase, at least a 20% increase, at least a 30% increase, at least a 40% increase, at least a 50% increase, at least a 60% increase, at least a 75% increase, at least a 100% increase, at least a 200% increase, at least a 300% increase, at least a 400% increase or at least a 500% increase in potency as compared to an equivalent amount of the liquid shale inhibitor, as measured by weight. In certain embodiments, the dried shale inhibitor additive and the liquid shale inhibitor may include the same shale inhibitor.

The dried shale inhibitor additive may be included in a treatment fluid including an aqueous base fluid. In certain embodiments, the treatment fluid may include one or more additional treatment additives in addition to the dried shale inhibitor additive. In certain embodiments, at least a portion of the dried shale inhibitor additive may dissolve in the treatment fluid. In certain embodiments, the dried shale inhibitor additive may be a solid powder that at least partially dissolves upon contact with the treatment fluid to produce a liquid shale inhibitor.

The treatment fluid of the present disclosure may include any base fluid known in the art, including an aqueous fluid, anon-aqueous fluid, or any combination thereof. The term “base fluid” refers to the major component of the fluid (as opposed to components dissolved and/or suspended therein), and does not indicate any particular condition or property of that fluid such as its mass, amount, pH, etc. Aqueous fluids that may be suitable for use in the methods and compositions of the present disclosure may include water from any source. Such aqueous fluids may include fresh water, salt water (e.g., water containing one or more salts dissolved therein), brine (e.g., saturated salt water), seawater, oil-in-water emulsions, or any combination thereof. The aqueous fluids may include one or more ionic species, such as those formed by salts dissolved in water. For example, seawater and/or produced water may include a variety of divalent cationic species dissolved therein. Examples of a non-aqueous fluid that may be suitable for use as a base fluid include, but are not limited to an oil, a hydrocarbon, an organic liquid, a mineral oil, a synthetic oil, an ester, or any combination thereof. Examples of suitable non-aqueous fluids (e.g., oleaginous fluids) that may be included in the base fluid include, but are not limited to, α-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, hydrocarbons, and combinations thereof. In certain embodiments, the treatment fluid may be an emulsion or an invert emulsion. In certain embodiments, the treatment fluid does not include an emulsion or an invert emulsion.

The treatment fluid of the present disclosure may include one or more treatment additives. Examples of treatment additives suitable for certain embodiments of the present disclosure include, but are not limited to a viscosifier, a wetting agent, a thinner, a rheology modifier, an emulsifier, a surfactant, a dispersant, an interfacial tension reducer, a pH buffer, a mutual solvent, a lubricant, a defoamer, a cleaning agent, and any combination thereof.

In some embodiments, the treatment fluid may include one or more salts including, but not limited to KCl, potassium acetate, NaCl, MgCl₂, CaCl₂, and any combination thereof. In some embodiments, the treatment fluid may include one or more salts in liquid form (e.g., dissolved in a fluid). In certain embodiments, the salt may include an anion selected from the group consisting of chloride, bromide, fluoride, an acetate, a formate, a silicate, and any combination thereof. In some embodiments, the salt may include a cation selected from the group consisting of potassium, sodium, magnesium, calcium, aluminum, barium, cesium, and any combination thereof. For example, in certain embodiments, a salt may be dissolved in a fluid to form a solution and mixed with the dried shale inhibitor additive to form a treatment fluid. In some embodiments, the treatment fluid may include one or more starches in liquid form.

In certain embodiments, the treatment fluid may include an additional solvent. Examples of additional solvents suitable for certain embodiments of the present disclosure include, but are not limited to an alcohol, a glycol, polyethylene glycol, acetone, and any combination thereof. In some embodiments, the additional solvent may include water.

The treatment additives may be present in the treatment fluid in an amount in a range of from about 0.1% to about 99% by weight, from about 0.1 to about 50% by weight, from about 10 to about 80% by weight, or from about 30 to about 70% by weight, all by weight of the treatment fluid. In some embodiments, treatment additives may be present in the treatment fluid in amount of 0.1%, 1%, 5%, 10%, 20%, 30%, 40%, 50%, 60%, 70%, 80%, or 90% by weight or higher, all by weight of the treatment fluid.

In certain embodiments, the dried shale inhibitor additive of the present disclosure may be added to the treatment fluid in an amount of from about 0.05% to about 50% by weight of the treatment fluid (e.g., about 0.05%, 0.1%, about 1%, about 5%, about 10%, about 15%, about 20%, about 25%, about 30%, about 35%, about 40%, about 45%, about 50%, etc.). In some embodiments, the dried shale inhibitor additive may be added to the treatment fluid in an amount of from about 1% to about 25% by weight of the treatment fluid. Alternatively, the amount of dried shale inhibitor additive may be expressed by weight of dry solids. For example, the dried shale inhibitor additive may be added to the treatment fluid in an amount of from about 0.1% to about 50% by weight of dry solids (e.g., about 0.1%, about 1%, about 2%, about 5%, about 10%, about 15%, about 20%, about 25%, about 30%, about 35%, about 40%, about 45%, about 50%, etc.). In some embodiments, the dried shale inhibitor additive may be added to the treatment fluid in an amount of from about 0.1% to about 15% by weight of dry solids.

In some embodiments, the dried shale inhibitor additive may be added to the treatment fluid in an amount of from about 0.1 pound per barrel (ppb) to about 100 ppb (e.g., about 0.1 ppb, about 0.5 ppb, about 1 ppb, about 2 ppb, about 3 ppb, about 4 ppb, about 5 ppb, about 6 ppb, about 7 ppb, about 8 ppb, about 9 ppb, about 10 ppb, about 15 ppb, about 20 ppb, about 30 ppb, about 40 ppb, about 50 ppb, about 60 ppb, about 70 ppb, about 80 ppb, about 90 ppb, about 100 ppb, etc.). In some embodiments, the dried shale inhibitor additive may be added to the treatment fluid in an amount of from about 0.5 ppb to about 20 ppb. In some embodiments, the dried shale inhibitor additive may be added to the treatment fluid in an amount of from about 0.1 ppb to about 15 ppb. In some embodiments, at least a portion of the dried shale inhibitor additive may dissolve in the treatment fluid.

In certain embodiments, the treatment fluids of the present disclosure may include lost circulation materials or bridging agents. Examples of lost circulation materials or bridging agents suitable for certain embodiments of the present disclosure include, but are not limited to ground marble, resilient graphitic carbon, walnut shells, calcium carbonate, magnesium carbonate, limestone, dolomite, iron carbonate, iron oxide, calcium oxide, magnesium oxide, perborate salts, and the like, and any combination thereof. In certain embodiments, lost circulation materials or bridging agents may include, but are not limited to, BARACARB® particulates (ground marble, available from Halliburton Energy Services, Inc.) including BARACARB® 2, BARACARB® 5, BARACARB® 25, BARACARB® 50, BARACARB® 150, BARACARB® 600, BARACARB® 1200; STEELSEAL® particulates (resilient graphitic carbon, available from Halliburton Energy Services, Inc.) including STEELSEAL® powder, STEELSEAL® 50, STEELSEAL® 150, STEELSEAL® 400 and STEELSEAL® 1000; WALL-NUT® particulates (ground walnut shells, available from Halliburton Energy Services, Inc.) including WALL-NUT® M, WALL-NUT® coarse, WALL-NUT® medium, and WALL-NUT® fine; BARAPLUG® (sized salt water, available from Halliburton Energy Services, Inc.) including BARAPLUG® 20, BARAPLUG® 50, and BARAPLUG® 3/300; BARAFLAKE® (calcium carbonate and polymers, available from Halliburton Energy Services, Inc.).

In some embodiments, the treatment fluids of the present disclosure optionally may include a weighting agent. Examples of suitable weighting agents include, but are not limited to barite, hematite, calcium carbonate, magnesium carbonate, iron carbonate, zinc carbonate, manganese tetraoxide, ilmenite, and any combination thereof. These weighting agents may be at least partially soluble or insoluble in the treatment fluid. In some embodiments, a weighting agent may be present in the treatment fluid in an amount of from about 1% to about 60% by weight of the treatment fluid (e.g., about 1%, about 5%, about 10%, about 15%, about 20%, about 25%, about 30%, about 35%, about 40%, about 45%, about 50%, about 55%, etc.). In some embodiments, the weighting agent may be present in the treatment fluid in an amount of from about 1% to about 35% by weight of the treatment fluid. In some embodiments, the weighting agent may be present in the treatment fluid in an amount of from about 1% to about 10% by weight of the treatment fluid. Alternatively, the amount of weighting agent may be expressed by weight of dry solids. For example, the weighting agent may be present in an amount of from about 1% to about 99% by weight of dry solids (e.g., about 1%, about 5%, about 10%, about 20%, about 30%, about 40%, about 50%, about 60%, about 70%, about 80%, about 90%, about 99%, etc.). In some embodiments, the weighting agent may be present in an amount of from about 1% to about 20% and, alternatively, from about 1% to about 10% by weight of dry solids.

The dried shale inhibitor additive of the present disclosure may be provided as a “dry mix” to be combined with a base fluid and/or other components prior to or during introducing the treatment fluid into the subterranean formation. Certain other components of the treatment fluid may also be provided as a dry mix. A dry mix composition may include two or more dry mix components. In some embodiments, a dry mix or dry mix composition may be designed to be mixed with a base fluid in an amount from about 1 to about 20 gallons per 94-lb sack of dry mix or dry mix composition (gal/sk). In certain embodiments, the dry mix or dry mix composition may be suitable for use with base fluids in the amount of 10 gal/sk. In some embodiments, the dry mix or dry mix composition may be suitable for use with base fluids in the amount of 13.5 gal/sk. Embodiments of the treatment fluids of the present invention may be prepared in accordance with any suitable technique. In some embodiments, the desired quantity of water may be introduced into a mixer followed by the dry mix or dry mix composition. For example, the dry mix composition may include a lost circulation material and additional solid additives. Additional liquid additives, if any, may be added to the base fluid as desired prior to, or after, combination with the dry mix or dry mix composition. This mixture may be agitated for a sufficient period of time to form a slurry. It will be appreciated by those of ordinary skill in the art, with the benefit of this disclosure, that other suitable techniques for preparing treatment fluids may be used in accordance with embodiments of the present invention.

In certain embodiments, the treatment fluids and dried shale inhibitor additives of the present disclosure may be effective over a range of pH levels. For example, in certain embodiments, the dried shale inhibitor additive of the present disclosure may provide effective shale inhibition from a pH of about 7 to about 12. Additionally, the treatment fluids of the present disclosure may be suitable for a variety of subterranean formations, including, but not limited to shale formations and carbonate formations.

In certain embodiments, the methods and compositions of the present disclosure optionally may include any number of additional additives. Examples of such additional additives include, but are not limited to, salts, surfactants, acids, proppant particulates, diverting agents, gas, nitrogen, carbon dioxide, surface modifying agents, tackifying agents, foamers, corrosion inhibitors, scale inhibitors, catalysts, clay control agents, biocides, friction reducers, antifoam agents, flocculants, additional shale inhibitors, fluid loss control additives, loss circulation materials, H₂S scavengers, CO₂ scavengers, oxygen scavengers, lubricants, viscosifiers, breakers, relative permeability modifiers, resins, wetting agents, coating enhancement agents, filter cake removal agents, antifreeze agents (e.g., ethylene glycol), cross-linking agents, curing agents, gel time moderating agents, curing activators, and the like. In some embodiments, the treatment fluid may contain rheology (viscosity and gel strength) modifiers and stabilizers. In certain embodiments, the additional additive may be a solid additive. In certain embodiments, the additional additive may be a solid additive that dissolves in an aqueous fluid (e.g., an aqueous liquid). A person skilled in the art, with the benefit of this disclosure, will recognize the types of additives that may be included in the fluids of the present disclosure for a particular application.

The methods and compositions of the present disclosure may be used in a variety of applications. These include downhole applications (e.g., drilling, fracturing, completions, oil production), use in conduits, containers, and/or other portions of refining applications, gas separation towers/applications, pipeline treatments, water disposal and/or treatments, and sewage disposal and/or treatments. In certain embodiments, a treatment fluid may be introduced into a subterranean formation. In some embodiments, the treatment fluid may be introduced into a wellbore that penetrates a subterranean formation. In certain embodiments, a wellbore may be drilled and the treatment fluid may be circulated in the wellbore during, before, or after the drilling. In some embodiments, the treatment fluid may be introduced at a pressure sufficient to create or enhance one or more fractures within the subterranean formation (e.g., hydraulic fracturing).

The methods and compositions of the present disclosure may directly or indirectly affect one or more components or pieces of equipment associated with the preparation, delivery, recapture, recycling, reuse, and/or disposal of the compositions of the present disclosure. For example, the methods and compositions may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the compositions of the present disclosure. The methods and compositions of the present disclosure may also directly or indirectly affect any transport or delivery equipment used to convey the fluid to a well site or downhole such as, e.g., any transport vessels, conduits, pipelines, trucks, tubulars, and/or pipes used to compositionally move fluids from one location to another, any pumps, compressors, or motors (e.g., topside or downhole) used to drive the fluids into motion, any valves or related joints used to regulate the pressure or flow rate of the fluids, and any sensors (i.e., pressure and temperature), gauges, and/or combinations thereof, and the like.

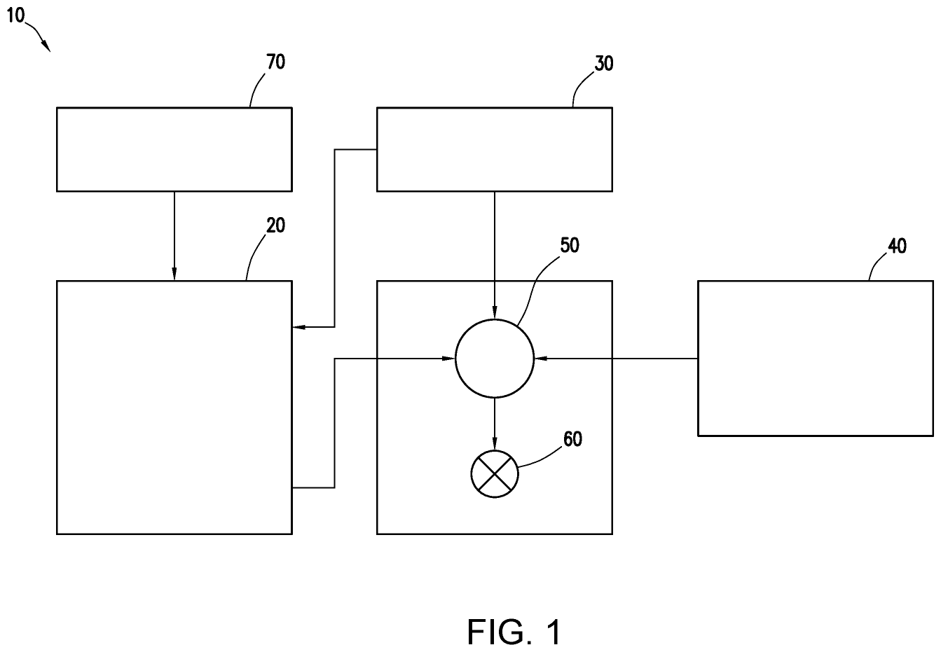

For example, and with reference to FIG. 1, the disclosed methods may directly or indirectly affect one or more components or pieces of equipment associated with a system 10, according to one or more embodiments. In certain embodiments, the system 10 includes a fluid producing apparatus 20, a fluid source 30, a dried shale inhibitor additive source 40, and a pump and blender system 50 and resides at the surface at a well site where a well 60 is located. The fluid can be a fluid for ready use in a treatment of the well 60. In other embodiments, the fluid producing apparatus 20 may be omitted and the fluid sourced directly from the fluid source 30.

The dried shale inhibitor additive source 40 may include at least one dried shale inhibitor additive for combination with a fluid. The system 10 may also include additive source 70 that provides one or more additives to alter the properties of the fluid. For example, the other additives 70 can be included to reduce pumping friction, to reduce or eliminate the fluid's reaction to the geological formation in which the well is formed, to operate as surfactants, and/or to serve other functions.

The pump and blender system 50 may receive the fluid and combine it with other components, including the dried shale inhibitor additive source 40 and/or additional components from the additives source 70. In certain embodiments, the resulting mixture may be pumped down the well 60 at a pressure suitable to introduce the fluid into one or more permeable zones in the subterranean formation. In certain instances, the fluid producing apparatus 20, fluid source 30, and/or dried shale inhibitor additive source 40 may be equipped with one or more metering devices or sensors (not shown) to control and/or measure the flow of fluids, dried shale inhibitor additives, proppants, diverters, bridging agents, and/or other compositions to the pumping and blender system 50. In certain embodiments, the metering devices may permit the pumping and blender system 50 to source from one, some, or all of the different sources at a given time, and may facilitate the preparation of fluids in accordance with the present disclosure using continuous mixing or “on-the-fly” methods. Thus, for example, the pumping and blender system 50 can provide just fluid into the well at certain times, just additives at other times, and combinations of those components at yet other times.

While not specifically illustrated herein, the disclosed methods and systems may also directly or indirectly affect any transport or delivery equipment used to convey wellbore compositions to the system 10 such as, e.g., any transport vessels, conduits, pipelines, trucks, tubulars, and/or pipes used to fluidically move compositions from one location to another, any pumps, compressors, or motors used to drive the compositions into motion, any valves or related joints used to regulate the pressure or flow rate of the compositions, and any sensors (e.g., pressure and temperature), gauges, and/or combinations thereof, and the like.

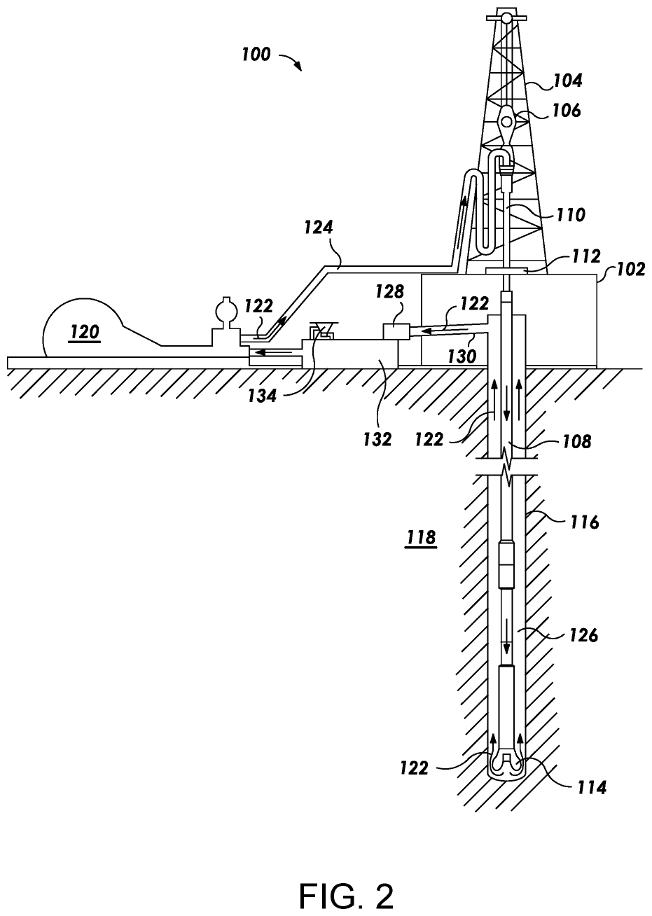

For example, and with reference to FIG. 2, the dried shale inhibitor additives of the present disclosure may directly or indirectly affect one or more components or pieces of equipment associated with an exemplary wellbore drilling assembly 100, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a wellbore 116 that penetrates various subterranean formations 118.

A pump 120 (e.g., a mud pump) circulates wellbore fluid 122 (e.g., a treatment fluid described herein) through a feed pipe 124 and to the kelly 110, which conveys the wellbore fluid 122 downhole through the interior of the drill string 108 and through one or more orifices in the drill bit 114 (or optionally through a bypass or ports (not shown) along the drill string and above the drill bit 114). The wellbore fluid 122 is then circulated back to the surface via an annulus 126 defined between the drill string 108 and the walls of the wellbore 116. At the surface, the recirculated or spent wellbore fluid 122 exits the annulus 126 and may be conveyed to one or more fluid processing unit(s) 128 via an interconnecting flow line 130. After passing through the fluid processing unit(s) 128, a “cleaned” wellbore fluid 122 is deposited into a nearby retention pit 132 (e.g., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure. The dried shale inhibitor additive of the present disclosure may be added to the wellbore fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the dried shale inhibitor additive of the present disclosure may be added to the wellbore fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the dried shale inhibitor additives of the present disclosure may be stored, reconditioned, and/or regulated until added to the wellbore fluid 122.

As mentioned above, the dried shale inhibitor additives of the present disclosure may directly or indirectly affect the components and equipment of the drilling assembly 100. For example, the dried shale inhibitor additives of the present disclosure may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and any fluid reclamation equipment. The fluid processing unit(s) 128 may further include one or more sensors, gauges, pumps, compressors, and the like used store, monitor, regulate, and/or recondition solid additives and/or lost circulation materials.

The dried shale inhibitor additives of the present disclosure may directly or indirectly affect the pump 120, which representatively includes any conduits, pipelines, trucks, tubulars, and/or pipes used to fluidically convey the treatment fluids downhole, any pumps, compressors, or motors (e.g., topside or downhole) used to drive the treatment fluids into motion, any valves or related joints used to regulate the pressure or flow rate of the dried shale inhibitor additive, and any sensors (i.e., pressure, temperature, flow rate, etc.), gauges, and/or combinations thereof, and the like. The dried shale inhibitor additive of the present disclosure may also directly or indirectly affect the mixing hopper 134 and the retention pit 132 and their assorted variations.

The dried shale inhibitor additives of the present disclosure may also directly or indirectly affect the various downhole equipment and tools that may come into contact with the dried shale inhibitor additive such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The dried shale inhibitor additive of the present disclosure may also directly or indirectly affect any downhole heat exchangers, valves and corresponding actuation devices, tool seals, packers and other wellbore isolation devices or components, and the like associated with the wellbore 116. The dried shale inhibitor additives of the present disclosure may also directly or indirectly affect the drill bit 114, which may include, but is not limited to roller cone bits, PDC bits, natural diamond bits, any hole openers, reamers, coring bits, etc.

The methods and compositions of the present disclosure may also directly or indirectly affect the various downhole equipment and tools that may come into contact with the dried shale inhibitor additive and/or treatment fluids such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. In some embodiments, the treatment fluid is introduced into a wellbore using one or more pumps.

An embodiment of the present disclosure is a method including providing a dried shale inhibitor additive that includes a precipitate of at least one liquid amine shale inhibitor; allowing at least a portion of the dried shale inhibitor additive to dissolve in a treatment fluid including an aqueous base fluid; and introducing the treatment fluid into a wellbore penetrating at least a portion of a subterranean formation.

Another embodiment of the present disclosure is a method including providing at least one liquid amine shale inhibitor; mixing the at least one liquid amine shale inhibitor with a solvent in which the at least one liquid shale inhibitor is substantially or entirely insoluble to produce a precipitate; and drying the precipitate to produce a dried shale inhibitor additive.

Another embodiment of the present disclosure is a composition including a dried shale inhibitor additive that includes a precipitate of at least one liquid amine shale inhibitor.

Another embodiment of the present disclosure is a method including providing a dried shale inhibitor additive that includes a precipitate of at least one liquid amine shale inhibitor; allowing at least a portion of the dried shale inhibitor additive to dissolve in a treatment fluid including an aqueous base fluid; and introducing the treatment fluid into a wellbore penetrating at least a portion of a subterranean formation, wherein the subterranean formation includes shale; and the method further includes allowing the shale inhibitor to interact with the shale to at least partially inhibit the shale. Optionally in this embodiment or any other embodiment disclosed herein, the liquid amine shale inhibitor includes at least one amine selected from the group consisting of: a primary amine, a secondary amine, a tertiary amine, a quaternary amine, a neutral species thereof, a protonated species thereof with a counter anion, a derivative thereof, and any combination thereof. Optionally in this embodiment or any other embodiment disclosed herein, the dried shale inhibitor additive is a solid powder. Optionally in this embodiment or any other embodiment disclosed herein, the precipitate of the at least one liquid amine shale inhibitor is precipitated using a solvent in which the at least one liquid shale inhibitor is substantially or entirely insoluble. Optionally in this embodiment or any other embodiment disclosed herein, the dried shale inhibitor additive is a component of a dry mix composition that includes the dried shale inhibitor additive and at least one other component. Optionally in this embodiment or any other embodiment disclosed herein, the dried shale inhibitor additive includes a precipitate of a homogenous liquid composite, the homogenous liquid composite including an aqueous liquid mixture that includes at least two liquid amine shale inhibitors. Optionally in this embodiment or any other embodiment disclosed herein, the dried shale inhibitor additive includes a precipitate of a homogenous liquid composite, the homogenous liquid composite including an aqueous liquid mixture that includes at least one liquid amine shale inhibitor and at least one solid additive dissolved in the aqueous liquid mixture.

Another embodiment of the present disclosure is a method including providing at least one liquid amine shale inhibitor; mixing the at least one liquid amine shale inhibitor with a solvent in which the at least one liquid shale inhibitor is substantially or entirely insoluble to produce a precipitate; and drying the precipitate to produce a dried shale inhibitor additive, wherein the solvent is miscible with water. Optionally in this embodiment or any other embodiment disclosed herein, the liquid amine shale inhibitor includes at least one amine selected from the group consisting of: a primary amine, a secondary amine, a tertiary amine, a quaternary amine, a neutral species thereof, a protonated species thereof with a counter anion, a derivative thereof, and any combination thereof. Optionally in this embodiment or any other embodiment disclosed herein, the method further includes dissolving at least a portion of the dried shale inhibitor additive in a treatment fluid including an aqueous base fluid; and introducing the treatment fluid into a wellbore penetrating at least a portion of a subterranean formation. Optionally in this embodiment or any other embodiment disclosed herein, the method further includes liquid blending an aqueous liquid mixture including the liquid amine shale inhibitor and at least a second liquid amine shale inhibitor to produce a homogenous liquid composite before mixing with the solvent. Optionally in this embodiment or any other embodiment disclosed herein, the method further includes liquid blending an aqueous liquid mixture including the liquid amine shale inhibitor and at least one solid additive dissolved in the aqueous liquid mixture to produce a homogenous liquid composite before mixing with the solvent.

Another embodiment of the present disclosure is a composition including a dried shale inhibitor additive that includes a precipitate of at least one liquid amine shale inhibitor, wherein the liquid amine shale inhibitor includes at least one amine selected from the group consisting of: a primary amine, a secondary amine, a tertiary amine, a quaternary amine, a neutral species thereof, a protonated species thereof with a counter anion, a derivative thereof, and any combination thereof. Optionally in this embodiment or any other embodiment disclosed herein, the dried shale inhibitor additive is a solid powder. Optionally in this embodiment or any other embodiment disclosed herein, the precipitate of the at least one liquid amine shale inhibitor is precipitated using a solvent in which the at least one liquid shale inhibitor is substantially or entirely insoluble. Optionally in this embodiment or any other embodiment disclosed herein, the dried shale inhibitor additive includes a precipitate of a homogenous liquid composite including an aqueous liquid mixture that includes at least two liquid amine shale inhibitors. Optionally in this embodiment or any other embodiment disclosed herein, the dried shale inhibitor additive includes a precipitate of a homogenous liquid composite including an aqueous liquid mixture that includes at least one liquid amine shale inhibitor and at least one solid additive dissolved in the aqueous liquid mixture.

To facilitate a better understanding of the present disclosure, the following examples of certain aspects of certain embodiments are given. The following examples are not the only examples that could be given according to the present disclosure and are not intended to limit the scope of the disclosure or claims.

### EXAMPLES

The following examples demonstrate the preparation of dried shale inhibitor additives and laboratory tests conducted to evaluate the potency and stability of the dried shale inhibitor additives according to some embodiments of the present disclosure.

### Example 1

In this example, a dried shale inhibitor additive was prepared. About 10 mL of liquid amine shale inhibitor (BaraSure™ W-674 Shale Stabilizer, available from Halliburton Energy Services, Inc.) and 50 mL of solvent in which the liquid shale inhibitor was substantially or entirely insoluble (isopropyl alcohol) were mixed together in a reaction vessel until a precipitation reaction occurred. The resulting precipitate was filtered through a filter paper and subsequently dried under vacuum. The purified precipitate product was a yellow dry powder.

### Example 2

In this example, the potency of the dried shale inhibitor additive prepared in Example 1 was tested. The dried shale inhibitor additive was added to water in an amount of about 0.5 pounds per barrel (ppb). The resulting solution was tested with colorimetric assay to determine the relative concentration of the dried shale inhibitor additive compared to the liquid BaraSure™ W-674 Shale Stabilizer. The colorimetric assay was used to determine a calibration curve for the concentration of BaraSure™ W-674 Shale Stabilizer in a concentration range from about 1 pounds per barrel (ppb) to about 7 pounds per barrel (ppb) by absorbance measurements at 600 nm. According to the calibration curve, a solution at 0.5 pounds per barrel (ppb) of dried shale inhibitor additive was observed to have the same active concentration as a solution at 1.6 pounds per barrel (ppb) of liquid BaraSure™ W-674 Shale Stabilizer. These results demonstrate that the dried shale inhibitor additive has at least a 300% increase in potency as compared to an equivalent amount of the liquid shale inhibitor, as measured by weight.

### Example 3

In this example, the stability of the dried shale inhibitor additive prepared in Example 1 was tested in terms of its hygroscopic properties. A small dry sample (about 100 mg) of the dried shale inhibitor additive in a container was exposed to the atmosphere at room temperature and pressure. After 3 days of exposure, the dried shale inhibitor additive remained a dry powder. After approximately 3 months, the dried shale inhibitor additive appeared to have taken up only a small amount moisture. These results demonstrate that the dried shale inhibitor additive is stable at room temperature and pressure, at least for shorter periods of time (e.g., under 3 months).

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a dried shale inhibitor additive that comprises a precipitate of at least one liquid amine shale inhibitor;
allowing at least a portion of the dried shale inhibitor additive to dissolve in a treatment fluid comprising an aqueous base fluid; and
introducing the treatment fluid into a wellbore penetrating at least a portion of a subterranean formation.

2. The method of claim 1, wherein the subterranean formation comprises shale; and the method further comprises:
allowing the shale inhibitor to interact with the shale to at least partially inhibit the shale.

3. The method of claim 1, wherein the liquid amine shale inhibitor comprises at least one amine selected from the group consisting of: a primary amine, a secondary amine, a tertiary amine, a quaternary amine, a neutral species thereof, a protonated species thereof with a counter anion, a derivative thereof, and any combination thereof.

4. The method of claim 1, wherein the dried shale inhibitor additive is a solid powder.

5. The method of claim 1, wherein the precipitate of the at least one liquid amine shale inhibitor is precipitated using a solvent in which the at least one liquid shale inhibitor is substantially or entirely insoluble.

6. The method of claim 1, wherein the dried shale inhibitor additive is a component of a dry mix composition that comprises the dried shale inhibitor additive and at least one other component.

7. The method of claim 1, wherein the dried shale inhibitor additive comprises a precipitate of a homogenous liquid composite, the homogenous liquid composite comprising an aqueous liquid mixture that comprises at least two liquid amine shale inhibitors.

8. The method of claim 1, wherein the dried shale inhibitor additive comprises a precipitate of a homogenous liquid composite, the homogenous liquid composite comprising an aqueous liquid mixture that comprises at least one liquid amine shale inhibitor and at least one solid additive dissolved in the aqueous liquid mixture.

9. A method comprising:
providing at least one liquid amine shale inhibitor;
mixing the at least one liquid amine shale inhibitor with a solvent in which the at least one liquid shale inhibitor is substantially or entirely insoluble to produce a precipitate; and
drying the precipitate to produce a dried shale inhibitor additive.

10. The method of claim 9, wherein the solvent is miscible with water.

11. The method of claim 9, wherein the liquid amine shale inhibitor comprises at least one amine selected from the group consisting of: a primary amine, a secondary amine, a tertiary amine, a quaternary amine, a neutral species thereof, a protonated species thereof with a counter anion, a derivative thereof, and any combination thereof.

12. The method of claim 9, further comprising:
dissolving at least a portion of the dried shale inhibitor additive in a treatment fluid comprising an aqueous base fluid; and
introducing the treatment fluid into a wellbore penetrating at least a portion of a subterranean formation.

13. The method of claim 9, further comprising:
liquid blending an aqueous liquid mixture comprising the liquid amine shale inhibitor and at least a second liquid amine shale inhibitor to produce a homogenous liquid composite before mixing with the solvent.

14. The method of claim 9, further comprising:
liquid blending an aqueous liquid mixture comprising the liquid amine shale inhibitor and at least one solid additive dissolved in the aqueous liquid mixture to produce a homogenous liquid composite before mixing with the solvent.

15. A composition comprising:
a dried shale inhibitor additive comprising a precipitate of at least one liquid amine shale inhibitor.

16. The composition of claim 15, wherein the liquid amine shale inhibitor comprises at least one amine selected from the group consisting of: a primary amine, a secondary amine, a tertiary amine, a quaternary amine, a neutral species thereof, a protonated species thereof with a counter anion, a derivative thereof, and any combination thereof.

17. The composition of claim 15, wherein the dried shale inhibitor additive is a solid powder.

18. The composition of claim 15, wherein the precipitate of the at least one liquid amine shale inhibitor is precipitated using a solvent in which the at least one liquid shale inhibitor is substantially or entirely insoluble.

19. The composition of claim 15, wherein the dried shale inhibitor additive comprises a precipitate of a homogenous liquid composite comprising an aqueous liquid mixture that comprises at least two liquid amine shale inhibitors.

20. The composition of claim 15, wherein the dried shale inhibitor additive comprises a precipitate of a homogenous liquid composite comprising an aqueous liquid mixture that comprises at least one liquid amine shale inhibitor and at least one solid additive dissolved in the aqueous liquid mixture.
